(19) United States
(12) Patent Application Publication
(10) Pub. No.: US 2013/0297509 A1
(43) Pub. Date: Nov. 7, 2013

(54) MOBILE PAYMENT USING DYNAMIC AUTHORIZATION CODE AND MULTI-PAYER SHARED CARD NUMBER

(71) Applicant: INFOSYS LIMITED, Bangalore (IN)

(72) Inventors: Sony Sebastian, Bangalore (IN); Rajesh Kalyanasundaram, Bangalore (IN)

(73) Assignee: Infosys Limited, Bangalore (IN)

(21) Appl. No.: 13/887,905

(22) Filed: May 6, 2013

(30) Foreign Application Priority Data
May 7, 2012 (IN) 1759/CHE/2012

(51) Int. Cl. G06Q 20/32

(52) U.S. Cl. CPC G06Q 20/3226
USPC 705/44

(57) ABSTRACT

Various technologies related to implementing payment via a mobile device are described. An authorization code and a credit card number can be provided by an issuer to a mobile device, which in turn provides the authorization code and the credit card number to a merchant. The merchant can then provide the authorization code and the credit card number to an issuing bank, which can reconcile the authorization code and the credit card number and issue payment authorization.

### BACKGROUND

Mobile devices have become ubiquitous. With the rise of mobile devices, various techniques for accomplishing payment via mobile devices have been implemented.

For example, one technique stores a consumer's credit card information in a secure element. When the consumer desires to make a payment, the credit card information in the secure element is accessed and provided to a merchant, who then processes the credit card information in a traditional fashion.

However, such an approach has various drawbacks and difficulties. For example, various parties participating in such an arrangement may wish to interpose themselves in the process, thus leading to a multiplicity of parties involved and fees. Such fees inevitably ultimately impact the consumer.

Although various approaches have been taken to address such difficulties, there is still a need to provide a secure, efficient, and consumer-friendly way to implement payment via a mobile device.

### SUMMARY

A variety of techniques can be used for effecting mobile payment technologies. A mobile device can participate on a conventional card network to accomplish payment to a merchant via an issuer.

A multi-user shared card number and an authorization code can be used to accomplish payment over a conventional payment processing system. However, a conventional credit card need not be involved.

Considerable convenience and efficiency in the payment process can be realized.

As described herein, a variety of other features and advantages can be incorporated into the technologies as desired.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system implementing the mobile payment technologies described herein.

FIG. 2 is a flowchart of an exemplary method of implementing the mobile payment technologies described herein.

FIG. 3 is a block diagram of an exemplary system implementing the mobile payment technologies described herein from an issuer perspective.

FIG. 4 is a flowchart of an exemplary method of implementing the mobile payment technologies described herein from an issuer perspective.

FIG. 5 is a block diagram of an exemplary system implementing reconciliation of an authorization code.

FIG. 6 is a flowchart of an exemplary method of reconciling an authorization code.

FIG. 7 is a flowchart of an exemplary method implementing the technologies described herein via a mobile device and point-of-sale unit.

FIG. 8 is a flowchart of an exemplary method implementing the technologies described herein.

FIG. 9 is a block diagram of an exemplary computing environment suitable for implementing any of the technologies described herein.

### DETAILED DESCRIPTION

### Example 1

### Exemplary Overview

The technologies described herein can be used for a variety of mobile payment scenarios. Adoption of the technologies can provide a convenient technique for paying via a mobile device via a relationship with a card issuer such as a bank.

The technologies can be helpful to those wishing to pay for goods or services over a conventional card network without having to use a physical credit card. Beneficiaries include card issuers, who wish to provide low-cost or free payment services to their customers and merchants while maintaining convenience and security. Customers can also greatly benefit from the technologies because they enjoy the ability to pay at a wide variety of locations that support conventional payment methods.

### Example 2

### Exemplary System Employing a Combination of the Technologies

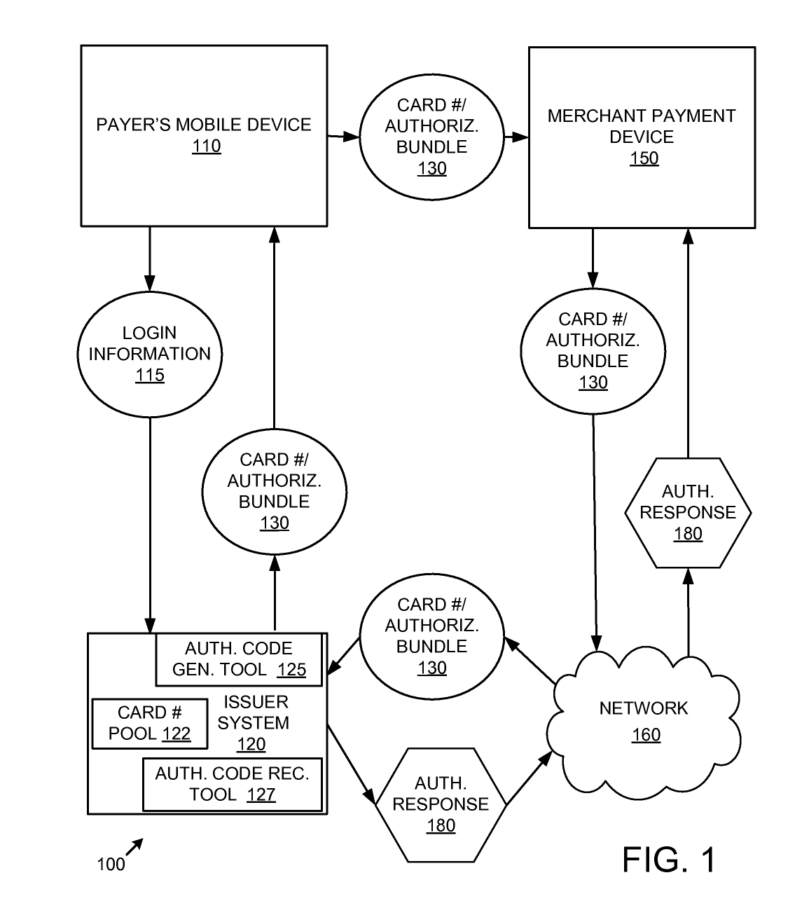

FIG. 1 is a block diagram of an exemplary system 100 implementing the mobile payment technologies described herein. In the example, one or more computers in a computing environment implement an issuer system 120.

The issuer system 120 accepts as input login information 115 for a user from a mobile device 110, and generates as output a multi-payer shared card number/authorization code bundle 130. As described herein, the issuer system 120 can include a card number pool 122, an authorization code generation tool 125, and an authorization code reconciliation tool 127.

The mobile device 110 accepts the bundle 130 as input and forwards it to the merchant payment device 150. As described herein, such forwarding can be accomplished via near-field communication, bar code (e.g., QR, two-dimensional, etc.), bump, or some other secure information transmission technique.

The merchant payment device 150 accepts the bundle 130 and transmits it to the network 160 (e.g., an acquirer network for the merchant or other network) as part of a payment authorization request, which communicates the bundle 130 to the issuer system 120.

The issuer system accepts the bundle 130 as input and outputs an authorization response 180 (e.g., indicating whether the transaction is authorized) back to the network 160.

The network 160 can then forward the authorization response 180 to the merchant payment device 150, which is configured to indicate whether the transaction is authorized (e.g., based on the authorization response 180).

Although not shown, the authorization response 180 can also be provided to the payer's mobile device 110. For example, SMS, in-application messages, push notifications, or the like can be used to communicate success or failure of the transaction to the mobile device 110.

Although depictions of the bundle 130 indicate that the card number and authorization code travel together, it is possible that the two be separated (e.g., travel over different channels) while remaining logically associated.

In practice, the systems shown herein, such as system 100 can be more complicated, with additional functionality, more complex inputs, and the like.

In any of the examples herein, the inputs, outputs, and tools can be stored in one or more computer-readable storage media or computer-readable storage devices.

### Example 3

### Exemplary Method of Applying a Combination of the Technologies

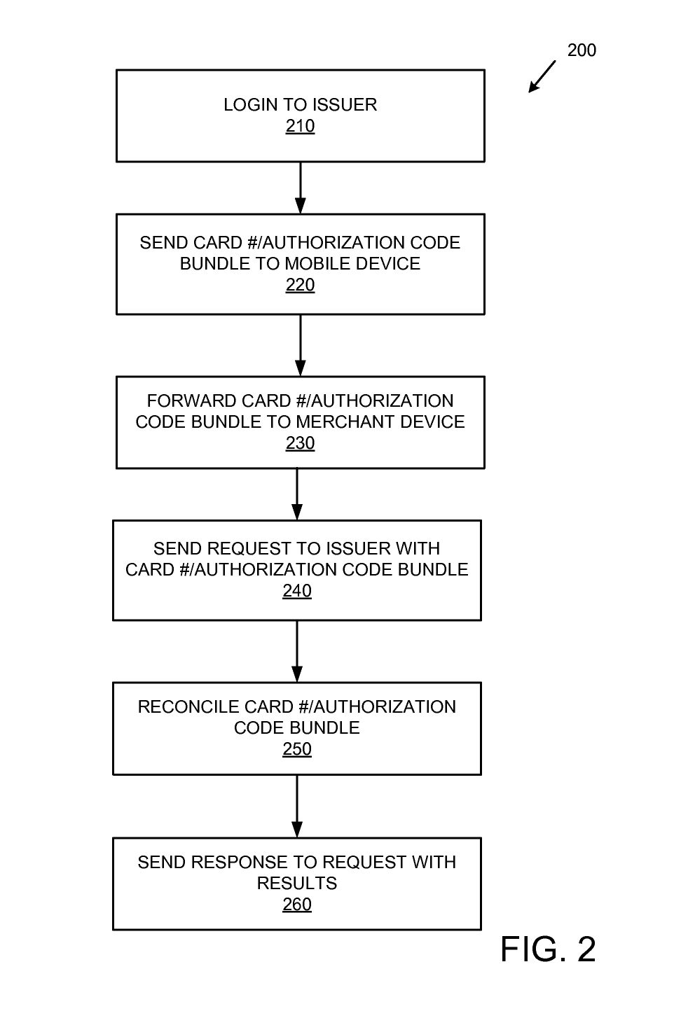

FIG. 2 is a flowchart of an exemplary method 200 of implementing the mobile payment technologies described herein and can be implemented, for example, in a system such as that shown in FIG. 1. The technologies described herein can be generic to the specifics of operating systems or hardware and can be applied in any variety of environments to take advantage of the described features.

At 210, a paying user logs in to an issuer system via a mobile device. Such log in can be accomplished via log in to a website or a mobile application that accomplishes login for the paying user.

At 220, after authentication of the paying user takes place, a multi-user shared card number and authorization code are sent to the mobile device. As described herein, a dummy card number can be employed. Such a technique allows the card to be used in a conventional card network. The authorization code can be generated as described herein.

At 230, the card number and authorization code are forwarded to the merchant payment device. As described herein, near field communication (NFC) can be used. As described herein, the authorization code can be placed in a user-defined field.

At 240, a payment authorization request is sent to the issuer with the card number/authorization code bundle. As described herein, the authorization code can be placed in a custom or user-defined field.

At 250, the card number/authorization code bundle are reconciled. For example, it can be determined whether the authorization code was indeed generated by the issuer, whether it is still valid, whether it is associated with the proper card number, and the like.

At 260, a response to the payment authentication request is sent (e.g., back to the merchant) with results of the reconciliation (e.g., is the payment authorized or not).

Subsequently, if the payment is authorized, actual payment by the issuer to the merchant occurs.

The method 200 and any of the methods described herein can be performed by computer-executable instructions stored in one or more computer-readable media (e.g., storage or other tangible media) or stored in one or more computer-readable storage devices.

### Example 4

### Exemplary Merchant Payment Device

In any of the examples herein, a merchant payment device can be a point-of-sale terminal, device for processing near field communication transactions, or the like.

### Example 5

### Exemplary Issuers

In any of the examples herein, an issuer can be any entity that participates as a card issuer on a card network. Such an issuer can be a bank, financial institution, or other entity wishing to avail itself of the technologies described herein.

An issuer can, but need not also issue physical cards for other transactions.

### Example 6

### Exemplary Issuer-Centric Approach

In any of the examples described herein, an issuer (e.g., bank) can benefit from the technologies. For example, the issuer can control the generation, distribution, and security of authorization codes, rather than relying on a third party. A shared pool of card numbers that resolve to the issuer ensure that transactions will be routed to the issuer, but new card numbers need not be generated for different paying customers or different transactions.

The issuer can then also assume the duty of authorizing the authorization codes that are distributed because they are routed to the issuer for authorization.

### Example 7

### Exemplary Multi-Payer Shared Card Number

As described herein, a multi-payer shared card number can be re-used for a plurality of different payers. One or more such card numbers can be stored in a pool of card numbers for use in the transactions described herein. The card numbers in the pool can resolve to (e.g., indicate in the number) the bank providing the card numbers. Such a card number is sometimes called “static” because it can be the same for different payers or transactions.

In any of the examples herein, a multi-payer shared card number can be of the format of a standard credit card number (sometimes called a “bank card number,” “debit card number,” “travel card number,” or the like). A standard such as ISO/IEC 7812 bank card numbers can be used. Such a standard can have provisions for an issuer identification number, major industry identifier, (e.g., part of the issuer identification number), a variable length individual account number, one or more check digits, and the like. For example, sixteen-digit numbers used by issuers such as Visa, MasterCard, and the like can be used. Fifteen-digit number used by issuers such as American Express can be used. Thirteen-digit number used by issuers such as Visa can be used.

The syntax of the issuer can also be observed. For example, certain issuers have certain blocks of numbers assigned to them (e.g., American Express numbers start with “37” or “34”). Also, card numbers can be generated such that they comply with a validation scheme, such as a checksum (e.g., a Luhn validation).

By using such an approach, merchants can accept and otherwise process multi-payer shared card numbers described herein without changing infrastructure for processing such numbers. Thus, an infrastructure-transparent multi-payer shared card number can be used as described herein.

Credit card security codes can also be supported. In any of the examples herein, the card number can also include other card data, such as a credit card security code. Generally, security codes are issued along with a card once along with issuance of the card. The technologies described herein can also follow the same procedure to issue the CVV, while providing the card number to the paying user. The security codes can remain unchanged for a specific period, as being practiced, and can be changed with the existing mechanism/process in place. Unlike conventional cards, the same card number can be associated with multiple card security codes (e.g., to extend the number of card numbers available).

Credit card security codes can be generated according to issuer convention, such as encrypting card information (e.g., credit card number, expiration date, and service code) with an encryption key. The expiration date can be set for the current month or some other date. Alternatively, multiple card security codes can be used for the card numbers as described herein.

Because the card number in the technologies described herein is not unique to the paying customer and may be re-used across different transactions, it is sometimes called a “dummy” card number. However, the card number is still recognized as valid and can follow conventional card number syntax. The card number processing network will accept the card number and process it; however, the actual identifying information is contained in the authorization code. The security code can be used to identify the paying customer, or it too can be dummy information.

### Example 8

### Exemplary Dynamic Authorization Code

In any of the examples herein, a dynamic authorization code can be used in conjunction with a multi-payer shared credit card number. The authorization code is sometimes called “dynamic” because a new one can be generated for different transactions or payers. The number can be generated in a variety of ways, including a pseudo-random number generator or the like. A check can be done to ensure that a similar pending dynamic authorization code does not currently exist (e.g., the code does not match an other dynamic authorization code that is currently outstanding). If so, a different code can be generated.

In practice, the authorization code can take the form of an identifier, such as an alpha-numeric or numeric identifier. The length can vary, with 8 or 16 digits being typical lengths as described herein.

### Example 9

### Exemplary Limited-validity Authorization Code

In any of the examples herein, the authorization code can be implemented as having limited validity.

The authorization code can be implemented as a short-lived authorization code (e.g., expiring after a few minutes, a few hours, or the like). Depending on the circumstances, the code can expire in five (5) minutes, five (5) hours, or some similar time period. Expired codes can be removed from the database or noted as expired. An attempt to use an expired code will fail (e.g., the authorization response indicates denial) and may or not be indicated as “expired” or simply “unauthorized.”

Also, authorization codes can be implemented as one-time authorization codes. For example, the authorization code is usable only once per time generated. After reconciling, the authorization code is rendered unusable (e.g., by removing the code from a list of authorized codes, denoting the code as used, or the like). In practice, the code may be reused at some time in the future if desired, but old codes can be tracked to prevent re-generation of the same code within a time period.

### Example 10

### Exemplary Bundling

As described herein, an authorization code can be bundled with a multi-payer shared card number. For example, the authorization code can be sent via a user-defined field in a request for payment that incorporates the shared card number. In a conventional transaction, the shared card number identifies the paying customer, but bundling allows the authorization code to travel in the network in a bundle with the shared card number. In any of the examples herein, the request for payment can be of a format for requesting payment authorization involving a bank card (e.g., a conventional payment authorization request requesting that a payment involving a bank card be authorized).

Upon receipt by the issuer, the authorization code can then be consulted to determine whether to authorize the transaction.

### Example 11

### Exemplary Multi-Payer Shared Card Number Pool

In any of the examples herein, an issuer can choose a shared card number from a pool of multi-payer shared card numbers. A bank identification number (BIN) can be reserved for the pool (e.g., card numbers in the pool have the bank identification number). In this way, incoming transactions can be quickly recognized as being unconventional transactions involving a bundled authorization number. Incoming requests for authorization of payment can be routed for reconciliation of the authorization code (e.g., to a reconciliation or authorization tool tool) responsive to determining that the to-be-verified multi-payer shared card number has the BIN.

So, responsive to identifying that the card number is associated with the pool of multi-payer shared card numbers, the incoming transaction can be processed as described herein (e.g., reconciling the authorization code).

### Example 12

### Exemplary Payment Authentication Request

In any of the examples herein, a payment authentication request is a request to determine whether payment is authorized (e.g., by an issuer). Such a request can include a custom or user-defined field into which the authorization code can be embedded.

The request can be transmitted over conventional infrastructure and eventually arrive at the issuer system. The issuer can then extract the authorization code and perform reconciliation to determine whether to authorize the request.

A response to the request is supported by the infrastructure and indicates at least whether the request is authorized or not.

### Example 13

### Exemplary Multi-Payer Shared Card Number Pre-Fetching

In any of the examples herein, a mobile payment application (e.g., executing on a mobile device) can pre-fetch a configurable number (e.g., 5 or the like) of card/authorization numbers.

Such fetching can be performed in the background for use during payment.

If a bundle expires, the mobile application can delete the bundle and fetch a replacement bundle. Such processing can take place in the background without intervention by a user.

Thus, a request for a card number and authorization code can be a pre-fetch request in anticipation of a possible future transaction.

In this way, payment at the merchant terminal can be performed quickly without having to log in to an application. Also, if the mobile device loses network connectivity, a payment can still be accomplished.

### Example 14

### Exemplary System from Issuer Perspective

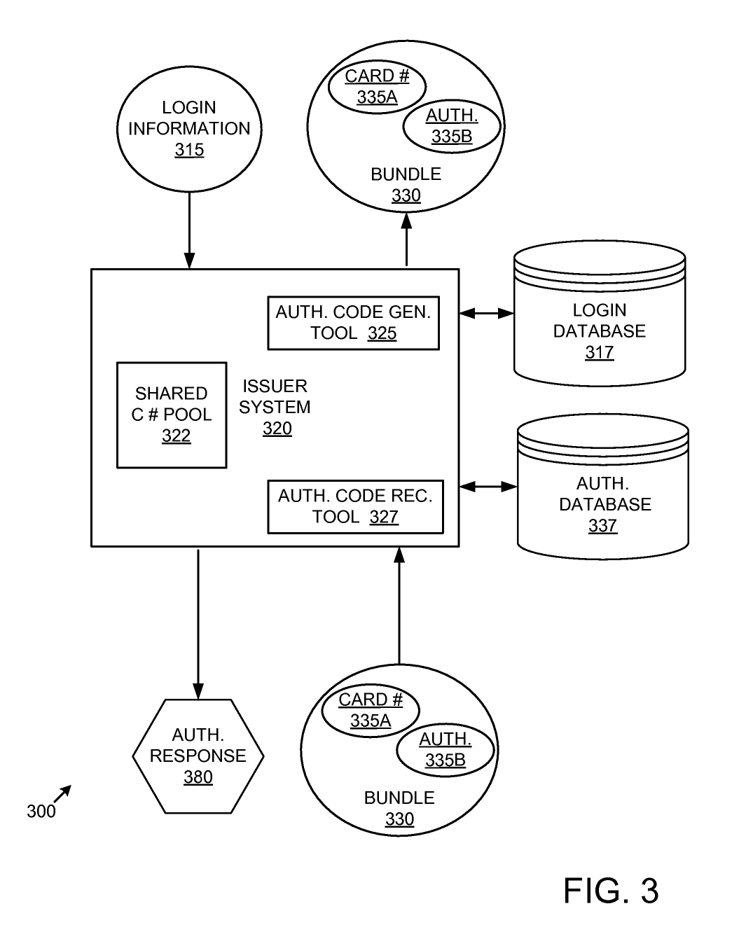

FIG. 3 is a block diagram of an exemplary system 300 implementing the mobile payment technologies described herein from an issuer perspective. In the example, an issuer system 320 is implemented by one or more computing devices. The shared card number pool 322, authorization code generation tool 325, and authorization reconciliation tool 327 can cooperate to accomplish payment processing for a paying user engaging in a transaction with a merchant.

The issuer system 320 accepts login information 315 as input. The login information can be provided as part of a login process that may be associated with a general website associated with the issuer system, a specialized website for payment, or provided by a mobile application without website involvement. Authentication of the user can be accomplished via a login database 317, which contains username and password information. Security measures can be taken to encrypt or otherwise protect such information.

The issuer system 320 outputs the bundle 330, which comprises a multi-user shared card number (e.g., chosen from the pool 322) and an authorization code (e.g., generated by the tool 325). An appropriate modification to the authorization code database 337 can be made to indicate that the code is authorized.

The issuer system 320 accepts as input the bundle 330, which is received as part of a payment authorization request (e.g., that resulted from the paying user's having provided the bundle 330 to a merchant payment device). The issuer system 320 outputs an authorization response 380 based on results provided by the authorization code reconciliation tool 327, which consults the authorization code database 337.

As described herein, a variety of features can facilitate accurate and efficient determination of whether a payment authorization request is authorized.

### Example 15

### Exemplary Method of Implementing Mobile Payment from Issuer Perspective

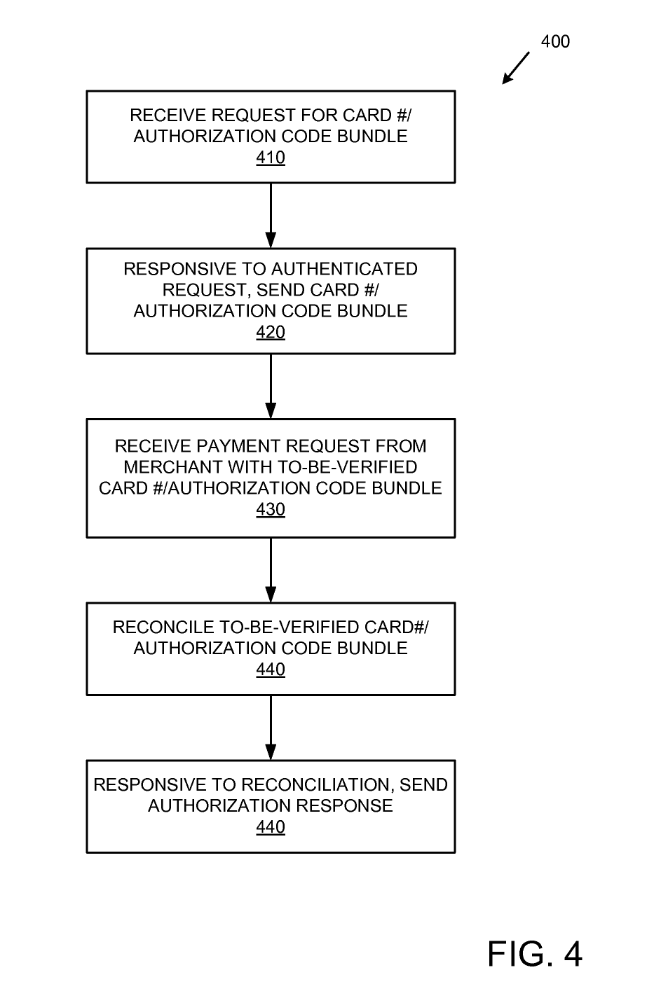

FIG. 4 is a flowchart of an exemplary method 400 of implementing the mobile payment technologies described herein from an issuer perspective and can be implemented, for example, in a system such as that shown in FIG. 3.

At 410, a request for a card number and authorization code bundle is received (e.g., from a mobile device). The request can be authenticated.

At 420, responsive to the authenticated request, a multi-payer shared card number and an authorization code are sent (e.g., to the mobile device). The authorization code is denoted as authorized for future reconciliation (e.g., constrained by limited validity as described herein). As described herein, an association between the number and the code can be stored for later reconciliation.

At 430, a request for payment authorization is received (e.g., from a merchant payment device) with a to-be-verified multi-payer shared card number and a to-be-verified authorization code. Although the information is typically received from a merchant device, it may be received indirectly (e.g., via a network, acquirer, or the like). The to-be-verified information can be the same information generated above, in which case, it is authorized (e.g., subject to limited validity as described herein).

At 440, the to-be-verified multi-payer shared card number and the to-be-verified authorization code are reconciled. In practice, reconciliation of the shared card number can be implied because the payment request has been routed to the issuer system. However, the shared card number can be included as part of the reconciliation process. For example, reconciliation can check to see if the authorization code is present in a database of authorized authorization codes.

At 450, responsive to the reconciliation results, an authorization response is sent in response to the payment authorization request. For example, if the authorization code is authorized (e.g., subject to the limited validity described herein), the payment request is authorized (e.g., a response is sent indicating that payment is authorized). In cases that the payment is not authorized, a negative result can be sent. A code (e.g., indicating “success,” “expired,” or the like) can accompany such a response.

### Example 16

### Exemplary System Implementing Reconciliation

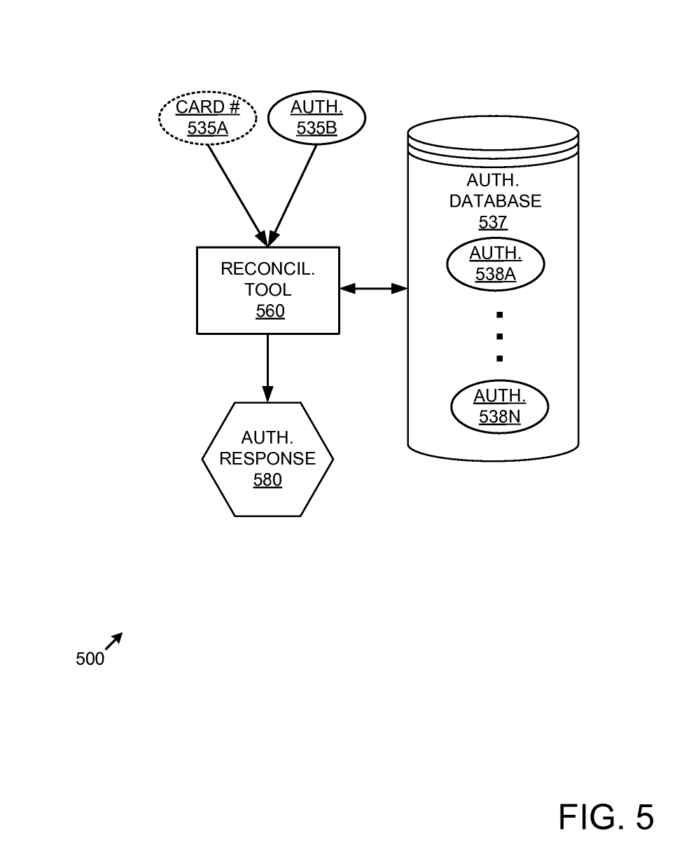

FIG. 5 is a block diagram of an exemplary system 500 implementing reconciliation of an authorization code and can be implemented in any of the examples herein to determine whether a payment request is authorized. In the example, the reconciliation tool 560 accepts a to-be-verified authorization code 535B as input and generates an authorization response 580, based on consultation with the authorization code database 537, which stores authorization codes 538A-N. The tool 560 can be incorporated into an authorization system such as that shown in FIG. 3.

A to-be-verified card number 535A can also be used as part of the reconciliation process. For example, a relationship between the authorization code 535B and the card number 535A can be verified. In such a scenario, lack of such a relationship indicates the code 535B is not authorized. Other aspects of the card number 535A (e.g., card verification codes) can be used as part of the process as desired. For example, if a card verification code does not match what has been stored by the issuer, the authorization code 535B is not authorized.

The tool 560 can provide a rich set of features for ensuring authenticity and security of the authorization code 535B.

### Example 17

### Exemplary Method of Reconciliation

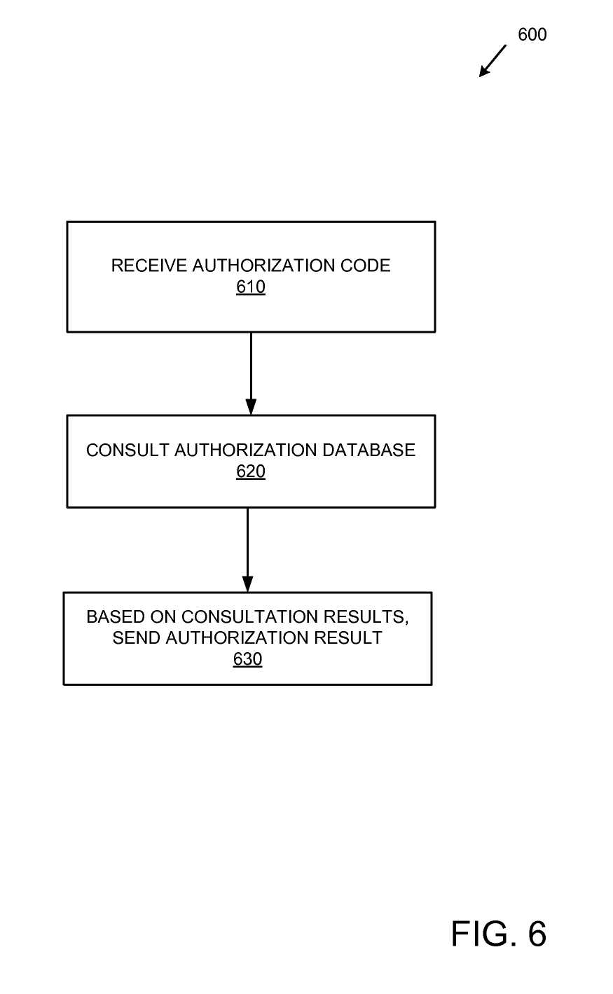

FIG. 6 is a flowchart of an exemplary method 600 of implementing reconciliation and can be implemented, for example, in a system such as that shown in FIG. 5.

At 610, the authorization code is received. As described herein, such a code can be received via a bundled transmission wherein the code is stored in a custom or user-defined field. So, the code can be extracted from such a user-defined or custom field.

At 620, an authorization database is consulted (e.g., to see if the authorization code is present or the like). Reconciliation can also be done subject to limited validity to determine whether the authorization code is expired, whether it has been used before (e.g., because it cannot be used more than once), and the like.

At 630, based on the consultation results, an authorization result is sent.

In addition to strict reconciliation, the authorization result response can also take into account the amount of the transaction (e.g., whether sufficient funds, credit, or the like remain in the paying customer's account with issuer).

### Example 18

### Exemplary Method of Implementing Mobile Payment

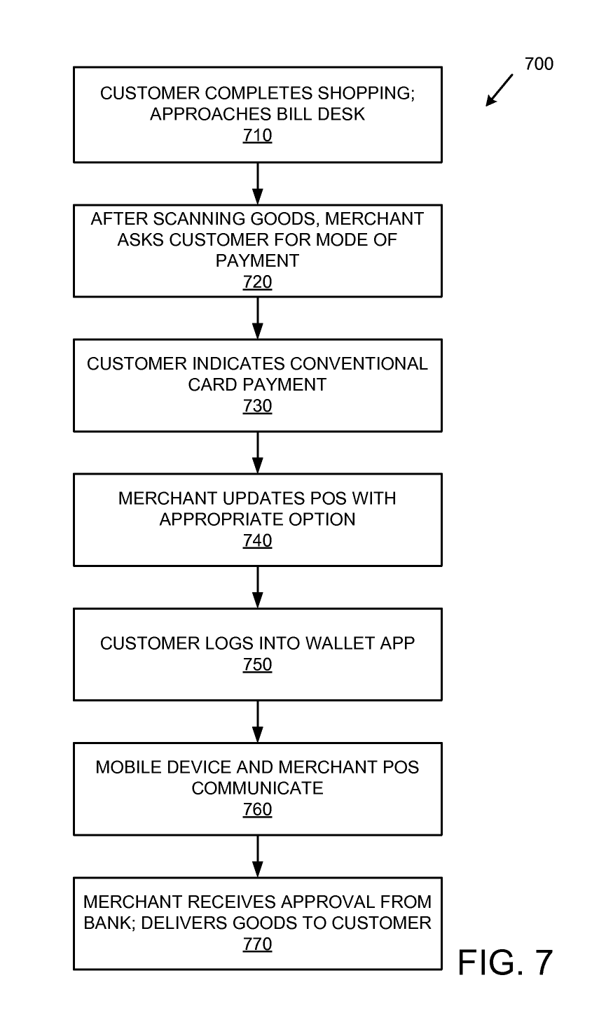

FIG. 7 is a flowchart of an exemplary detailed method 700 of implementing mobile payment via a mobile device and point-of-sale unit.

At 710, a customer completed shopping and approaches the bill desk (e.g., checkout location).

At 720, after scanning the goods, a merchant asks the paying customer for mode of payment. Although goods are described, services can also be supported.

At 730, the customer indicates that conventional card payment (e.g., credit card, MasterCard, VISA, or the like) payment will be used.

At 740, the merchant updates the point of sale unit with the appropriate option.

At 750, the paying customer logs into a wallet application on the mobile device. For example, a PIN, biometric, username/password, or other log in technique can be supported.

At 760, the mobile device and the merchant point of sale unit communicate. For example, the customer can wave the mobile device against the point of sale unit (e.g., to accomplish near-field communication). Although near-field communication can be used, alternatively, communication with the point of sale unit can be accomplished via a barcode (e.g., QR code, two-dimensional code, or the like), a bump, or any secure transmission technique.

Processing as described herein takes place without further action by the paying customer or the merchant.

At 770, the merchant approves approval from the bank and delivers the goods to the paying customer.

### Example 19

### Exemplary Method of Implementing Mobile Payment

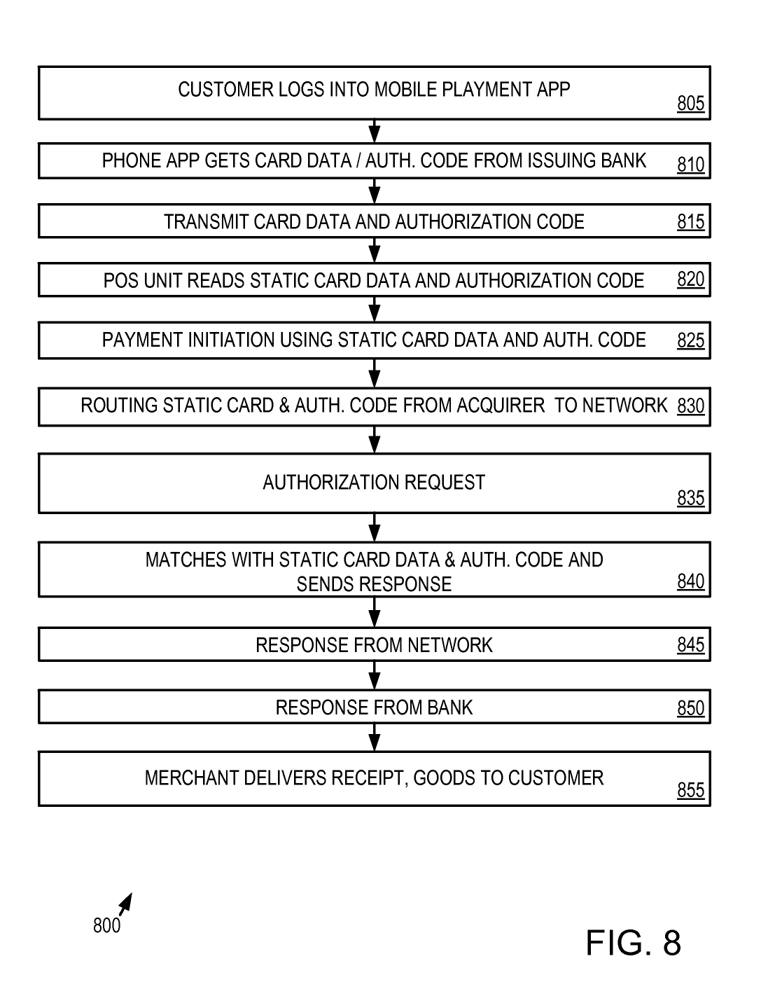

FIG. 8 is a flowchart of an exemplary method 800 of implementing mobile payment.

At 805, the customer logs into the mobile payment application (e.g., a mobile wallet application) on the mobile device.

At 810, the application gets the card data (e.g., number, security code, or both) and authorization code from the issuing bank.

At 815, the customer mobile payment application transmits the card data and authorization code.

At 820, the point of sale unit reads the card data and authorization code from the mobile device.

At 825, payment initiation using the card data and authorization code is directed to the acquirer.

At 830, the card data and authorization code are routed to the card network (e.g., MasterCard, VISA, or the like).

At 835, the authorization request is sent to the card number issuing bank.

At 840, the issuing bank matches the card data and authorization code and sends a response to the card network.

At 845, the response from the card network is sent back to the acquirer.

At 850, the response form the bank is sent from the acquirer to the merchant device.

At 855, the response is displayed on the merchant device. The merchant delivers a receipt for payment and provides the goods to the paying customer.

### Example 20

### Exemplary Further Description

The technologies described herein can implement a mobile payment scheme which uses a near field communication (NFC) transmitter embedded in a mobile device to send out a payment request that contains a dynamic, limited-validity authorization code and a static credit/debit card number to the Point of Sale (POS) terminal.

Instead of NFC, the technologies can take advantage of bar code (e.g., QR, two-dimensional, etc.), a bump, or any other secure information transmission technique.

The mobile user logs in to the mobile payment application using the user's credentials (e.g., username & password) and gets a limited validity authorization code from the issuing bank for the transaction the user about to do. The mobile user then waves the mobile phone against the NFC POS terminal which transmits the static card number along with the authorization code on to the POS terminal.

The transaction passes through the traditional payment route of acquirer switch, network operator and finally hits the issuer switch or the card issuing bank. The card issuing bank identifies the static card number sent by the mobile device as a NFC mobile payment transaction and then validates the authorization code. If the authorization code is valid, then the transaction is performed and response is sent accordingly. If the authorization code is expired, then the transaction is declined.

### Example 21

### Exemplary Advantages

Implementing the technologies herein may result in any one or more of the advantages described as follows:

The card issuing bank's dependency on a trusted service manager (TSM) (e.g., to manage a secure element) can be avoided. As the static card number and authorization code is received dynamically from the card issuing bank before the transaction, there is no need to store the card details in the secure element of the mobile phone. This makes the deployment of NFC-based mobile payment very quick and easy. The NFC-based mobile payment depicted herein can be deployed using any mobile phone equipped with NFC transmitter chip. This solution will work seamlessly with the existing POS infrastructure.

The customers get a secure feeling that their card information is not compromised, as the customer's actual card details are never transferred over the air or stored in the mobile phone secure element.

### Example 22

### Exemplary Features

The technologies described herein can implement any one or more of the following features:

A credit or debit card number is not stored in the secure element (SE) of the mobile phone. In-fact, SE is not required.

Payment processing can be done using limited validity, one time use authorization code and static credit/debit card number generated by a card issuing bank to the mobile payment application. The customer will have to login to the mobile payment application to receive the authorization code.

Customer can log into mobile payment application using the customer's username and password to receive the limited validity, one time use authorization code.

A single or a set of Static credit or debit card number(s) are used for the NFC-based mobile phones by the card issuing bank. Static credit or debit card number is the number sent by the card issuing bank to the NFC based mobile payment applications before conducting any transaction.

### Example 23

### Exemplary Further Features

The technologies described herein can implement any one or more of the following features:

Using the technologies herein, the card issuing banks can deploy mobile wallet application without dependency on Mobile network operators, TSMs and handset manufacturers (especially for the secure elements).

The security of mobile payments is increased by not storing card details on the mobile phone SE.

The customer can change his mobile phone without any worries of the credit card information being stolen from the SE, as the SE need not be present.

### Example 24

### Exemplary Pre-requisite

In order to use the technologies herein, a user can register.

The customer is registered with the card issuing bank for mobile payment service. After successful registration the customer gets a customer ID and a password (e.g., MPIN or Mobile PIN). The customer downloads the mobile payment application from the bank's website or an application store.

### Example 25

### Exemplary Use

The customer completes the shopping and approaches the billing counter. After scanning the goods, the merchant asks the customer for the mode of payment. The customer wants to pay using mobile phone equipped with NFC and registered with the card issuing bank for NFC payment. The merchant updates the POS terminal with appropriate option.

The customer opens the mobile payment application on the customer's mobile device. The customer can login to the card issuing bank's website using a username which can be a mobile number or customer ID. The communication between the mobile payment application and card issuing bank happens over IP based network. The wireless part of the communication can be on Wi-Fi, 2G, 3G or 4G network, or the like. The card issuing bank authenticates the customer by using MPIN set by the customer during the registration process.

After successful login, the mobile payment application requests an Authorization code and static credit/debit card number from the card issuing bank by sending the credentials. On successful authentication, the card issuing bank responds with the static credit/debit card number along with the authorization code.

The customer selects the payment at POS menu in the mobile payment application. Then waves the mobile phone against the NFC enabled POS terminal.

The POS terminal reads the static credit/debit card information and Authorization code in the message format as prescribed by payment network. The authorization code will be embedded in the payment request message transmitted to the NFC based POS terminal. Unused custom fields of the payment request message format will be used for sending the Authorization code. The field in which the Authorization code is sent can be parsed and understood only by the card issuing bank.

The POS terminal routes the payment request to the Acquirer switch.

The Acquirer switch routes the transaction to the Master/Visa network based on the card type.

The network operator (Master/Visa) identifies the card issuing bank based on the static card number. The transaction is routed to the card issuing bank.

The card issuing bank has the database of Authorization codes previously issued to all the Mobile payment applications and the corresponding credit/debit card number. The card issuing banking server matches the authorization code and processes the payment, if necessary funds are available in the account. The success or failure response is sent back to the network operator (MasterCard, VISA, etc.)

The network operator passes the response back to the Acquirer switch.

The payment response (success or failure) reaches the merchant POS terminal.

On successful transaction the merchant generates the bill and provides the payment receipt to the customer.

### Example 26

### Exemplary Computing Environment

The techniques and solutions described herein can be performed by software, hardware, or both of a computing environment, such as one or more computing devices. For example, computing devices include server computers, desktop computers, laptop computers, notebook computers, handheld devices, netbooks, tablet devices, mobile devices, PDAs, and other types of computing devices.

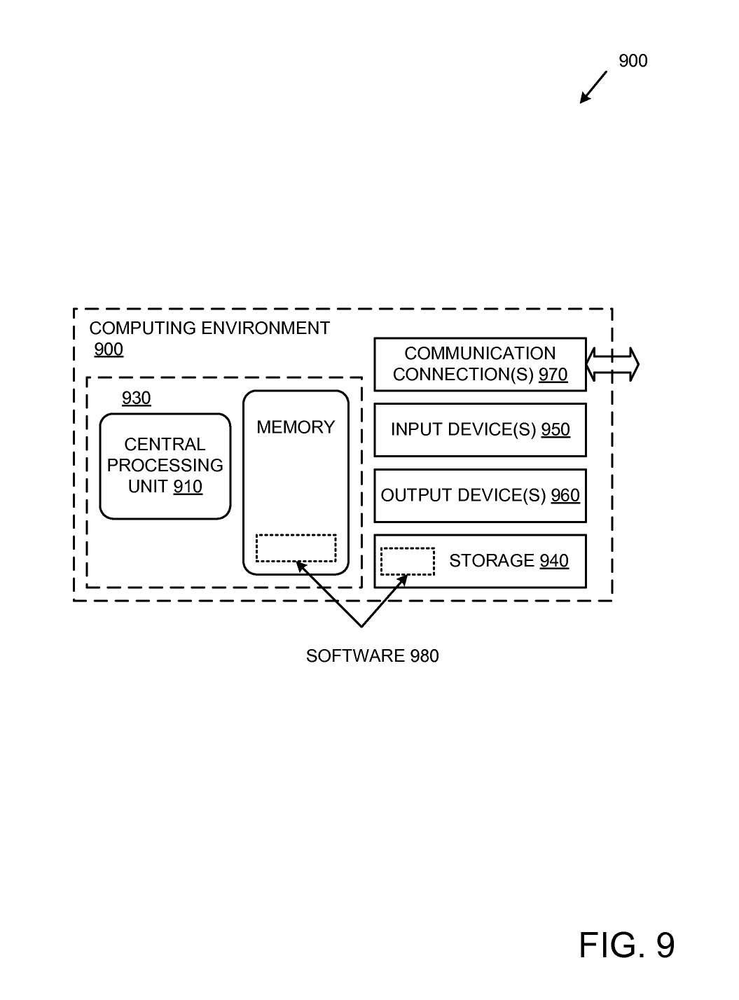

FIG. 9 illustrates a generalized example of a suitable computing environment 900 in which the described technologies can be implemented. The computing environment 900 is not intended to suggest any limitation as to scope of use or functionality, as the technologies may be implemented in diverse general-purpose or special-purpose computing environments. For example, the disclosed technology may be implemented using a computing device comprising a processing unit, memory, and storage storing computer-executable instructions implementing the mobile payment technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, program modules may be located in both local and remote memory storage devices

With reference to FIG. 9, the computing environment 900 includes at least one processing unit 910 coupled to memory 920. In FIG. 9, this basic configuration 930 is included within a dashed line. The processing unit 910 executes computer-executable instructions and may be a real or a virtual processor. In a multi-processing system, multiple processing units execute computer-executable instructions to increase processing power. The memory 920 may be volatile memory (e.g., registers, cache, RAM), non-volatile memory (e.g., ROM, EEPROM, flash memory, etc.), or some combination of the two. The memory 920 can store software 980 implementing any of the technologies described herein.

A computing environment may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 900.

The storage 940 may be removable or non-removable, and includes magnetic disks, magnetic tapes or cassettes, CD-ROMs, CD-RWs, DVDs, or any other computer-readable media which can be used to store information and which can be accessed within the computing environment 900. The storage 940 can store software 980 containing instructions for any of the technologies described herein.

The input device(s) 950 may be a touch input device such as a keyboard, mouse, pen, or trackball, a voice input device, a scanning device, or another device that provides input to the computing environment 900. For audio, the input device(s) 950 may be a sound card or similar device that accepts audio input in analog or digital form, or a CD-ROM reader that provides audio samples to the computing environment. The output device(s) 960 may be a display, printer, speaker, CD-writer, or another device that provides output from the computing environment 900.

The communication connection(s) 970 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Non-Transitory Computer-Readable Media

Any of the computer-readable media herein can be non-transitory (e.g., memory, magnetic storage, optical storage, or the like).

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, magnetic storage, optical storage, or the like). Such instructions can cause a computer to perform the method.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method implemented at least in part by a computing device, the method comprising:
receiving a request for a card number and an authorization code from a mobile device;
responsive to the request, sending a multi-payer shared card number and an authorization code;
receiving a request for payment authorization comprising a to-be-verified multi-payer shared card number and a to-be-verified authorization code from a merchant device;
reconciling the to-be-verified multi-payer shared card number and the to-be-verified authorization code; and
responsive to determining that the to-be-verified multi-payer shared card number and the to-be-verified authorization code are authorized, sending an authorization response to the merchant device indicating authorization of payment.

2. One or more computer-readable storage devices comprising computer-executable instructions causing a computer to perform the method of claim 1.

3. The method of claim 1 wherein:
the authorization code is a short-lived authorization code.

4. The method of claim 1 wherein:
the authorization code is usable only once per time generated.

5. The method of claim 1 wherein the method further comprises:
after reconciling, the authorization code is rendered unusable.

6. The method of claim 1 wherein reconciling comprises:
determining whether the authorization code is expired; and
determining whether the authorization code has already been used.

7. The method claim 1 wherein the method further comprises:
storing an association between the multi-payer shared card number and the authorization code;
wherein the reconciling is performed via the stored association.

8. The method of claim 1 wherein:
the to-be verified authorization code is embedded in the request for payment authorization; and
the request for payment authorization is of a format for requesting payment authorization involving a bank card.

9. The method of claim 1 further comprising:
extracting the to-be verified authorization code from a user-defined field.

10. The method of claim 1 wherein the method further comprises:
choosing the multi-payer shared card number from a reusable pool of one or more multi-payer shared card numbers.

11. The method of claim 10 wherein the method further comprises:
incorporating a card security code into the multi-payer shared card number;
wherein the reconciling reconciles the card security code.

12. The method of claim 1 wherein:
the multi-payer shared card number and the authorization code are received via transmission by the mobile device to the merchant device;
and the merchant device comprises a point of sale device.

13. The method of claim 12 wherein:
the transmission by the mobile device is accomplished via near field communication.

14. The method of claim 12 wherein:
the transmission by the mobile device is accomplished via a QR code.

15. The method of claim 1 wherein:
the request for the card number and the authorization code comprises a pre-fetch request in anticipation of a possible future transaction.

16. The method of claim 15 further comprising:
indicating the authorization code as expired after a predetermined time period; and
indicating denial in the authorization response to the merchant device.

17. An issuer-centric payment authorization system encoded on one or more computer-readable storage media and comprising:
one or more multi-payer shared card numbers associated with a bank;
an authentication code generation tool configured to generate a plurality of authentication codes;
an authentication reconciliation tool operable to accept a to-be-verified multi-payer shared card number and a to-be-verified authentication code and output a verification result; and
a database storing the plurality of authentication codes as associated with respective of the multi-payer shared card numbers and indicating whether respective of the authentication codes are authorized.

18. The issuer-centric payment authorization system of claim 17 wherein:
the plurality of authentication codes are short-lived authentication codes.

19. The issuer-centric payment authorization system of claim 17 wherein:
the one or more multi-payer shared card numbers associated with the bank comprise a plurality of bank card numbers having a same bank identification number (BIN);
wherein incoming requests for authorization of payment are routed for reconciliation responsive to determining that the to-be-verified multi-payer shared card number has the BIN.

20. A computer system comprising:
a processor; and
memory storing computer-executable instructions causing the computer system to perform:
conducting an authenticated login by a payer customer device associated with a payer customer;
choosing a shared static card number from a pool of card numbers shared with other payer customers;
generating a dynamic authorization code via a pseudo-random technique, wherein the generating comprises ensuring that the dynamic authorization code does not match an other dynamic authorization code that is currently outstanding;
after the authenticated login, sending the shared static credit card number and the dynamic authorization code to the payer customer device;
receiving a payment authentication request from a merchant device conducting a transaction with the payer customer device, wherein the payment authentication request comprises the shared static credit card number and the dynamic authorization code, wherein the dynamic authorization code is embedded in a custom field of the payment authentication request;
verifying that the shared static credit card number and the dynamic authorization code are authorized; and
responsive to the verifying, sending a response back to the merchant device authorizing the payment authentication request.
